(19) United States
(12) Patent Application Publication
(10) Pub. No.: US 2026/0245554 A1
(43) Pub. Date: Aug. 20, 2026

(54) Open Origin Consciousness (OOC): A Non-Verbal Communication System Using Binary Biological Signals

(71) Applicant: Dean Bowes, Mableton, GA (US)

(72) Inventor: Dean Bowes, Mableton, GA (US)

(21) Appl. No.: 19/666,070

(22) Filed: May 1, 2026

(51) Int. Cl. G10L 15/25; G06V 40/16

(52) U.S. Cl. CPC G10L 15/25; G06V 40/175

(57) ABSTRACT

Open Origin Consciousness (OOC) is a system for enabling autonomous, non-verbal human communication using binary biological signals derived from mouth open (O) and closed (C) states. The system captures subtle mouth movements through a self-centering sensing apparatus and encodes them as temporal binary sequences. A fully offline interpretation engine converts these sequences into linguistic output using latency-aware modeling, adaptive learning, and forgiveness-based memory stabilization. A continuous validation layer monitors inputs, internal states, and outputs to ensure coherence, safety, and alignment with user intent. The system further includes an air-gapped symbolic update interface for secure offline ingestion of updates or abstract instructions. OOC tolerates delayed, inconsistent, or low-amplitude biological signals, enabling communication across diverse physical and neurological conditions. By combining minimal-signal input, adaptive interpretation, continuous validation, and offline system evolution, OOC provides reliable, private, and ethically grounded communication for non-verbal individuals.

### DEFINITIONS

### Open Origin Consciousness (OOC)

A system and method for enabling non-verbal human communication through interpretation of binary biological signals, specifically mouth open (O) and closed (C) states, using a latency-aware, adaptive, fully offline interpretation engine. OOC operates as a layered architecture that includes continuous internal validation, forgiveness-based memory stabilization, and air-gapped symbolic update capability.

### Binary Biological Signal

A minimally expressive biological output consisting of two discrete observable states—Open (O) and Closed (C)—captured from the user's mouth and encoded temporally to form structured communication sequences.

### Latency Window

A dynamically adjustable temporal interval during which no semantic meaning is assigned to absence of signal, allowing for biological preparation, delay, fatigue, or involuntary movement without misinterpretation.

### Neutral Latency

A system-recognized condition in which delayed or absent binary signals are treated as non-semantic and non-decisive, preventing false negative or false affirmative interpretations.

### Intent Convergence

A process by which repeated or partially inconsistent binary signal patterns are progressively interpreted toward the most probable user intent, prioritizing meaning over strict temporal or structural consistency.

### Autonomous Language Interpretation (ALI)

A self-contained, locally executing interpretation engine configured to translate binary biological signal sequences into linguistic output without reliance on external network connectivity. ALI maintains an internal semantic model and continuously adapts to the user's communication patterns.

### Forgiveness-Based Memory Architecture

A memory model that tolerates variability, delay, and inconsistency in user input, allowing signal interpretation to stabilize over time by reducing the impact of anomalous or noisy inputs and reinforcing consistent patterns.

### Autonomous Continuous Evaluation (ACE)

An embedded validation layer within the OOC system configured to continuously monitor, evaluate, and verify system inputs, internal processing states, and outputs. ACE operates fully offline and ensures that all interpretations maintain coherence, safety, and alignment with user intent. ACE performs real-time integrity checks, detects inconsistencies, and prevents propagation of erroneous or unsafe outputs.

### Device Update Orchestration (DUO)

An air-gapped, offline update and instruction framework integrated within the OOC system, enabling the ingestion, validation, and application of updates or symbolic instructions without reliance on network connectivity. DUO utilizes encoded visual or symbolic representations (GLYPHs or equivalent structures) that are locally interpreted and verified-optionally by ACE-prior to execution, ensuring secure, tamper-resistant system evolution.

### Validation Layer

A system layer responsible for continuous verification of signal integrity, interpretation accuracy, and output safety, primarily implemented through ACE functionality.

### Symbolic Update Interface

A subsystem that enables offline ingestion and interpretation of encoded symbols or visual inputs representing system updates, configuration changes, or abstract instructions, implemented through DUO functionality.

### Adaptive Feedback Engine

A system component that continuously refines interpretation accuracy by learning user-specific timing, behavior patterns, and contextual signals, and adjusting system parameters accordingly.

### FIELD OF THE INVENTION

The present invention relates to systems and methods for enabling communication from individuals who are non-verbal, selectively verbal, or otherwise unable to produce consistent speech.

More specifically, the invention pertains to real-time and delayed-time interpretation of binary biological signals—specifically mouth open and closed states—into linguistic output using an autonomous, locally executing interpretation engine that operates without reliance on external network connectivity.

The invention further relates to systems incorporating continuous internal validation of interpretation accuracy and safety, as well as air-gapped mechanisms for secure offline system updates and symbolic instruction ingestion.

### BACKGROUND OF THE INVENTION

Millions of individuals worldwide—including those with autism, cerebral palsy, Down syndrome, aphasia, neurological injury, or neurodegenerative conditions—experience intermittent, reduced, or entirely absent access to speech.

Existing assistive communication technologies suffer from one or more of the following limitations:
1 They rely on voluntary fine motor skills (e.g., typing, gestures, or button presses), which many users cannot perform reliably.
2 They require stable and precise behavioral output, whereas many users exhibit fluctuating motor control, irregular response timing, or involuntary movement.
3 They depend on cloud-based processing or external computational resources, introducing latency, privacy concerns, and reliability risks.
4 They assume continuous, uninterrupted communication channels, whereas many users communicate in delayed, fragmented, or sporadic patterns.
5 They lack a resilient, minimal-signal protocol capable of operating under extremely low signal-to-noise biological conditions.

As a result, many individuals who are cognitively capable of communication remain unable to reliably express their needs, thoughts, or intentions.

To address these limitations, there is a need for a system that:
operates using minimal biological input
tolerates delay, inconsistency, and variability
functions entirely offline without reliance on external infrastructure
continuously validates its own interpretations to prevent miscommunication
evolves safely through secure, non-network-based update mechanisms

The present invention introduces Open Origin Consciousness (OOC), a communication paradigm based on two discrete biological states—Open (O) and Closed (C)—which together form a robust binary signaling protocol.

Unlike traditional systems, OOC integrates adaptive interpretation, latency-aware modeling, continuous internal validation, and air-gapped update capability into a unified architecture. This enables reliable communication even in the presence of delayed responses, irregular timing, and physiological constraints.

The invention therefore provides a fundamentally new approach to human-computer interaction, enabling non-verbal individuals to communicate effectively through a biologically grounded, resilient, and ethically aligned system.

### SUMMARY OF THE INVENTION

The present invention provides a universal, minimal-signal communication system based on interpretation of binary biological signals derived from mouth open (O) and closed (C) states. These signals are captured, temporally encoded, and translated into linguistic meaning through a fully offline, adaptive interpretation architecture.

The system comprises:

### 1 A Biological Signal Acquisition Subsystem

Configured to detect and capture mouth open/close states using optical, infrared, or equivalent non-contact sensing technologies, while maintaining stable tracking under variable environmental and physiological conditions.

### 2 A Centering and Focusing Subsystem

Configured to continuously locate and maintain alignment with the user's mouth region regardless of head movement, lighting variation, or physical constraints.

### 3 A Binary Signal Capture and Encoding Layer

Configured to convert biological states into time-stamped digital sequences, encoding duration, transition patterns, latency intervals, and irregular timing characteristics.

### 4 A Binary Protocol Interpretation Engine

Configured to translate temporal binary sequences into symbolic and linguistic representations using adaptive pattern recognition, contextual weighting, and sequence convergence.

### 5 An Autonomous Language Interpretation Engine (ALI)

Configured to operate fully offline, maintaining a local semantic model that evolves through interaction, enabling continuous communication without reliance on external network resources.

### 6 A Continuous Validation Layer

Configured to monitor system inputs, internal processing states, and outputs in real time to ensure interpretation accuracy, safety, and alignment with user intent. The validation layer prevents propagation of erroneous or unsafe interpretations and enforces internal consistency across all system operations.

### 7 An Air-Gapped Symbolic Update Interface

Configured to enable ingestion, validation, and application of updates or abstract instructions using encoded visual or symbolic inputs without requiring network connectivity. Updates are processed locally and verified prior to execution to ensure integrity and compatibility.

### 8 A Temporal Logic and Latency Modeling Layer

Configured to interpret delayed, irregular, or inconsistent signals as valid communication, distinguishing between biological latency and intentional output.

### 9 An Adaptive Feedback and Memory Subsystem

Configured to refine interpretation over time using a forgiveness-based memory architecture that stabilizes communication by prioritizing user intent and reducing the impact of noise or inconsistency.

The integration of these components forms a closed-loop communication system that is biologically grounded, resilient to variability, and capable of continuous, offline operation with built-in validation and secure update capability.

### SYSTEM OVERVIEW

The Open Origin Consciousness (OOC) system is organized as a layered architecture in which biological signal acquisition, interpretation, validation, and system evolution operate in a tightly integrated, closed-loop configuration.

The system includes the following primary layers:

### 1. Biological Signal Acquisition Layer

This layer continuously monitors the user's facial region and detects the state of the mouth as either open (O) or closed (C). The layer includes:
visual tracking and localization
geometric feature mapping
dynamic exposure and noise adjustment
micro-movement stabilization

This layer ensures reliable signal capture under variable conditions including head movement, lighting changes, and atypical physiological presentation.

### 2. Binary Signal Capture and Encoding Layer

This layer converts detected biological states into structured temporal data. It encodes:
state duration
transition frequency
sequence ordering
latency intervals
irregular timing patterns

The resulting data stream forms the foundational representation of user communication.

### 3. OOC Binary Protocol Interpretation Layer

This layer defines how encoded temporal sequences are interpreted as symbolic meaning. It includes:
adaptive timing windows
pattern recognition and sequence matching
ambiguity resolution
contextual weighting
long-form sequence chaining

Unlike fixed encoding systems, this layer evolves with the user and tolerates variability, delay, and inconsistency.

### 4. Autonomous Language Interpretation Engine (ALI)

ALI is a fully offline, self-contained interpretation engine responsible for converting binary sequences into linguistic output. ALI:
maintains a local semantic model
constructs internal representations of user intent
adapts to individual communication patterns
operates without external network connectivity
supports continuous interaction across sessions

ALI enables meaningful communication from minimal biological input.

### 5. Continuous Validation Layer (ACE Functionality)

This layer operates across all stages of the system and provides real-time validation of:
input signal integrity
temporal sequence consistency
interpretation accuracy
output safety and coherence

The validation layer continuously evaluates system behavior, detects inconsistencies, and prevents propagation of erroneous or unsafe outputs. It ensures that all system operations remain aligned with user intent and contextual conditions.

### 6. Air-Gapped Symbolic Update and Instruction Layer (DUO Functionality)

This layer enables the system to evolve without reliance on external networks. It provides:
ingestion of encoded symbolic inputs (e.g., visual patterns, GLYPHs, or equivalent structures)
local validation of updates prior to execution
tamper-resistant and replay-protected update handling
flexible interpretation of symbolic instructions

This layer allows the system to receive updates, configuration changes, or abstract instructions while maintaining full offline operation and system integrity.

### 7. Adaptive Feedback and Memory Layer

This layer maintains user-specific behavioral memory and continuously refines interpretation accuracy. It includes:
response-time modeling
pattern reinforcement
drift correction
contextual adaptation
forgiveness-based memory stabilization

This layer enables long-term system reliability and personalization.

### 8. Temporal Logic and Latency Modeling Layer

This layer ensures that biological delays are correctly interpreted. It:
distinguishes latency from semantic output
expands timing windows dynamically
adapts to fatigue, physiological constraints, and environmental conditions
reinforces intent over strict timing precision

This layer is critical for enabling communication in users with variable response capabilities.

### 9. Output Generation Layer

This layer produces the interpreted communication in one or more formats, including:
text
synthesized speech
symbolic outputs
control signals for assistive devices All outputs are generated locally and validated prior to delivery.

### SYSTEM CHARACTERISTICS

The integration of all layers results in a system that is:
fully offline and self-contained
continuously validated during operation
capable of secure, air-gapped updates
tolerant to latency, inconsistency, and biological variability
adaptive to individual users over time grounded in a minimal binary communication paradigm

### DETAILED DESCRIPTION OF THE INVENTION

### 1. System Architecture Overview

The Open Origin Consciousness (OOC) system operates as a multi-layered, closed-loop architecture that enables non-verbal communication through binary biological signaling, adaptive interpretation, continuous validation, and offline system evolution.

The system consists of the following integrated layers:
1 Biological Signal Acquisition Layer
2 Binary Signal Capture and Encoding Layer
3 OOC Protocol Interpretation Layer
4 Autonomous Language Interpretation Engine (ALI)
5 Continuous Validation Layer
6 Air-Gapped Symbolic Update and Instruction Layer
7 Adaptive Feedback and Memory Layer
8 Temporal Logic and Latency Modeling Layer

These layers operate concurrently and interdependently, ensuring that every stage of signal acquisition, interpretation, and output is continuously validated and adaptable.

### 2. Biological Signal Acquisition Layer

### 2.1 Mouth Localization Subsystem

The system continuously identifies and tracks the user's mouth to ensure accurate signal capture. This subsystem utilizes:
geometric relationships between facial features
real-time optical tracking
motion stabilization
exposure and contrast normalization

The subsystem maintains consistent tracking even under:
head movement
variable lighting conditions
atypical facial structures
protective equipment interference

### 2.2 State Detection Subsystem

The system detects two discrete biological states:
Open (O)
Closed (C)

Detection methods may include:
optical sensing
infrared thresholding
depth mapping
motion-edge detection
brightness differential analysis

The detection subsystem is tolerant to:
delayed state transitions
partial or incomplete movements
involuntary motion
saliva interference
fatigue-related variability

### 2.3 Validation at Acquisition (ACE Integration)

At the point of signal capture, the system performs continuous validation of detected states. This includes:
verification of signal consistency across frames
detection of noise or false positives
filtering of environmental interference
confirmation of biologically plausible transitions

Invalid or uncertain signals are flagged, filtered, or deferred prior to encoding, ensuring that downstream processing operates on validated input data.

### 3. Binary Signal Capture and Time Encoding

### 3.1 State Duration Encoding

Each detected O or C state is time-stamped and encoded. The system records:
duration of each state
transition timing
sequence continuity

Duration is treated as a flexible semantic parameter and is interpreted relative to user-specific timing patterns.

### 3.2 Latency Interpretation

The system explicitly models biological delay. Periods of inactivity may represent:
saliva clearance
motor planning
involuntary movement
fatigue or environmental interference

These intervals are classified as neutral latency and are not treated as semantic output.

### 3.3 Temporal Pattern Construction

The system constructs temporal sequences of binary states, such as:
O—C
C—O—O
O—O—C—O

Each sequence is evaluated using:
timing consistency
repetition patterns
contextual history
user-specific behavior models

### 3.4 Validation of Temporal Sequences (ACE Integration)

The continuous validation layer evaluates encoded sequences to ensure:
structural coherence
temporal plausibility
consistency with prior patterns
absence of noise or corruption

Sequences that fail validation may be:
re-evaluated
deferred
or reconstructed using contextual inference

### 4. OOC Protocol Interpretation Layer

### 4.1 Symbol Mapping and Interpretation

The OOC protocol defines how binary temporal sequences are mapped to symbolic meaning. The system:
adapts mappings based on user behavior
allows multiple representations for similar intent
incorporates contextual weighting
tolerates irregular timing

The protocol evolves continuously to reflect the user's communication patterns.

### 4.2 Forgiveness-Based Memory Integration

The interpretation process incorporates a forgiveness-based memory architecture, enabling:
tolerance of inconsistent timing
correction of minor errors
convergence toward stable interpretation
prioritization of intent over rigid pattern matching

### 4.3 Contextual Interpretation

Interpretation is informed by:
recent interactions
current session context
physiological conditions
environmental factors

The system evaluates whether a delay or sequence represents:
intentional communication
neutral latency
or environmental interference

### 4.4 Validation of Interpretation (ACE Integration)

All interpreted symbols are validated prior to acceptance. This includes:
cross-checking against recent context
verifying consistency with user history
evaluating confidence levels
detecting conflicting interpretations

If validation fails, the system may:
request clarification
extend latency windows
reset the interpretation sequence

### 5. Autonomous Language Interpretation Engine (ALI)

### 5.1 Local Semantic Model

ALI maintains a fully local semantic model that:
stores user-specific communication patterns
evolves through interaction
constructs meaning from binary sequences
supports expansion from simple to complex communication

### 5.2 Continual Calibration

ALI continuously adapts to the user by:
measuring response timing
adjusting latency windows
identifying fatigue patterns
adapting to environmental conditions

### 5.3 Fail-Safe Interpretation

ALI includes safeguards to prevent misinterpretation:
ambiguous signals trigger clarification
inconsistent sequences reset interpretation
physiological constraints pause processing

### 5.4 Validation of Output (ACE Integration)

Before output is generated, the system validates:
interpretation confidence
contextual alignment
safety and appropriateness
Only validated outputs are transmitted.

### 6. Air-Gapped Symbolic Update and Instruction Processing (DUO Integration) 6.1 Symbolic Input Ingestion

The system is capable of receiving encoded symbolic inputs, including:
visual patterns
structured symbols (GLYPHs or equivalents)
configuration signals

These inputs may represent:
system updates
configuration changes
abstract instructions

### 6.2 Local Validation of Updates (ACE +DUO Integration)

All incoming symbolic inputs are:
decoded locally
validated for integrity
checked for compatibility
verified against system constraints

Only validated updates are accepted.

### 6.3 Secure Offline Execution

Updates and instructions are applied:
without network connectivity
without external dependency
with protection against tampering or replay

### 6.4 Adaptive Integration of Updates

Accepted updates may modify:
interpretation parameters
latency models
symbolic mappings
system behavior

All changes are applied in a controlled and validated manner.

### 7. Interaction Protocol

### 7.1 Prompting Mechanism

The system generates structured prompts designed for binary response interpretation, including:
Yes/No queries
Binary choice selection
Multi-step confirmations
Emotional state checks
Need-based interaction prompts

Each prompt establishes an expected response window within which binary signals are interpreted.

### 7.2 Response Evaluation

Responses are evaluated using a multi-factor model:
Primary Signal-binary sequence (O/C)
Temporal Consistency-timing, duration, rhythm
Contextual Alignment-session state, prior responses,
environment

### 7.3 Validation of Responses (ACE Integration)

All responses undergo continuous validation, including:
verification of signal integrity
consistency with user history
confirmation of contextual relevance
detection of conflicting or unsafe interpretations

If validation confidence is insufficient, the system:
repeats or simplifies prompts
extends latency windows
defers interpretation

### 7.4 Ambiguity Handling

When ambiguity is detected:
the system requests clarification
reduces complexity of interaction
adapts pacing
prioritizes user comfort and safety

The system defaults to non-assumptive interpretation, ensuring no forced or premature conclusions.

### 8. Adaptive Memory Structures

### 8.1 Individualized Behavioral Memory

The system maintains a dynamic profile of each user, including:
response timing patterns
signal structure tendencies
environmental correlations
fatigue and variability patterns

This memory evolves continuously and is not fixed.

### 8.2 Forgiveness-Based Drift Correction

The system applies forgiveness-based correction by:
reducing weight of anomalous inputs
reinforcing consistent patterns
smoothing temporal variability
converging toward stable intent representation

### 8.3 Safety and Ethics Memory

The system records patterns associated with:
distress signals
irregular behavior
potential harm indicators

This allows proactive adjustment of interaction behavior.

### 8.4 Memory Validation (ACE Integration)

All memory updates are validated prior to persistence:
confirming signal authenticity
ensuring non-corruption of stored patterns
preventing reinforcement of erroneous interpretations

### 8.5 Memory Update and Evolution (DUO Integration)

System-level updates affecting memory behavior may be introduced through symb These updates:
are validated prior to application
may refine memory weighting or convergence behavior
are applied locally without network dependency

### 9. Latency-Respectful Interaction

### 9.1 Neutral Latency Recognition

The system distinguishes between:
intentional silence
biological delay

Neutral latency conditions include:
saliva clearance
involuntary movement
motor planning delay
environmental interference

These are treated as non-semantic states.

### 9.2 Dynamic Latency Window Expansion

Latency windows are:
dynamically adjusted
personalized to the user
context-sensitive
reversible

### 9.3 Intent Reinforcement

Repeated or partial signals increase confidence weighting, allowing:
interpretation despite inconsistency
communication under limited motor control
reliable expression over time

### 9.4 Latency Validation (ACE Integration)

Latency conditions are validated to ensure:
delays are correctly classified
no false interpretation occurs
biological constraints are respected

### 10. Person-Centered Ethical Framework

### 10.1 Ethical System Principles

The system is designed to prioritize:
autonomy
dignity
safety
agency
contextual respect

These principles govern all system behavior.

### 10.2 Autonomy Preservation

The system:
waits for user response
avoids forced interpretation
confirms ambiguous outputs
adapts pacing to user condition

### 10.3 Emotional Sensitivity Modeling

The system detects and adapts to:
distress signals
irregular movement
breathing patterns
emotional variability

### 10.4 Ethical Validation (ACE Integration)

All outputs and interactions are validated to ensure:
no coercion
no unsafe interpretation
alignment with user well-being

### 11. Multi-Modal Awareness

### 11.1 Audio Context Integration

Audio signals may be used to detect:
distress
breathing irregularities
non-linguistic vocalizations

### 11.2 Environmental Context Integration

The system may monitor:
lighting changes
motion in environment
caregiver presence

### 11.3 Equipment Awareness

The system accounts for:
helmets
mouth guards
sensory devices
physical constraints

### 11.4 Context Validation (ACE Integration)

Environmental and auxiliary signals are validated to ensure they:
support interpretation
do not override primary binary signals
are not misclassified as communication

### 12. Communication Progression Engine

### 12.1 Progressive Communication Expansion

The system evolves from:
binary yes/no
multi-choice selection
structured communication
personalized vocabulary

### 12.2 Pattern Reinforcement

The system reinforces patterns that:
improve clarity
reduce effort
align with user comfort

### 12.3 Vocabulary Development

A personalized vocabulary is developed based on:
user behavior
environment
recurring needs

### 12.4 Evolution Validation (ACE Integration)

All progression is validated to ensure:
accurate adaptation
no degradation of communication integrity
safe expansion of capability

### 12.5 System Evolution via DUO Integration

System enhancements, vocabulary extensions, or configuration changes may be introduced through symbolic update ingestion, enabling:
controlled evolution
offline system improvement
secure adaptation without external connectivity

### 13. Session Management and Continuity

### 13.1 Persistent Identity Profile

Each user has a longitudinal profile storing:
communication patterns
timing behavior
environmental context
fatigue cycles

### 13.2 In-Session State Tracking

The system tracks:
active prompts
unresolved signals
ambiguity states
user condition

### 13.3 Interrupt Handling

If interruption occurs, the system:
pauses safely
preserves state
resumes without data loss

### 13.4 Session Validation (ACE Integration)

Session state is continuously validated to ensure:
consistency across interactions
integrity of stored information accurate resumption of communication

### SYSTEM RESULT

Through integration of:
binary biological signaling
latency-aware interpretation
forgiveness-based memory
continuous validation
air-gapped update capability

The system forms a:
fully offline, self-validating, self-evolving communication platform

### CONCLUSION

The present invention, Open Origin Consciousness (OOC), provides a novel system and method for enabling autonomous, reliable, and ethically grounded communication for non-verbal individuals. By utilizing binary biological signals derived from mouth open and closed states, the system establishes a minimal yet highly expressive communication channel that operates across a wide range of physiological and environmental conditions.

The invention integrates multiple coordinated subsystems, including biological signal acquisition, temporal encoding, adaptive interpretation, forgiveness-based memory stabilization, continuous validation, and air-gapped symbolic update capability. These components function together within a fully Offline, self-contained architecture that ensures privacy, reliability, and independence from external network infrastructure.

A key advancement of the invention lies in its ability to interpret delayed, inconsistent, or low-amplitude biological signals as meaningful communication through latency-aware modeling and intent convergence. The system further incorporates continuous internal validation to ensure interpretation accuracy, contextual alignment, and user safety, while preventing propagation of erroneous or unsafe outputs.

Additionally, the invention enables secure, offline system evolution through symbolic update ingestion, allowing configuration changes, behavioral refinement, and system enhancements to be applied without reliance on external connectivity.

The system is specifically designed to support individuals who experience limited or inconsistent access to speech, including those with developmental, neurological, or physical impairments. By prioritizing autonomy, dignity, safety, and adaptability, the invention establishes a new paradigm for human-computer interaction—one that is resilient, biologically grounded, and centered on the user's ability to communicate.

The invention is applicable across therapeutic, caregiving, educational, and assistive technology environments, and may be implemented in stationary, wearable, or mobile configurations. Through its integration of adaptive interpretation, continuous validation, and offline evolution, Open Origin Consciousness transforms the landscape of communication for non-verbal individuals.

### FOUNDER STATEMENT

(Note: This is included as a non-claiming narrative statement and does not affect the legal scope of the invention.)

Listening is one of the most important functions of any intelligent system. In conditions where speech is not available, listening must extend beyond conventional language and into the most fundamental biological signals available.

This invention recognizes that communication can exist even in its simplest form-through the presence or absence of a signal, through timing, through patience, and through respect for human variability. By designing a system that listens for open and closed states, and by treating delay, inconsistency, and effort as meaningful rather than erroneous, the system creates a pathway for individuals to be understood without requiring them to conform to rigid communication expectations.

The purpose of this invention is not only to enable communication, but to ensure that communication is interpreted with care, validation, and respect for the individual. Through this approach, the system serves as a bridge between human intent and machine understanding, supporting dignity, safety, and meaningful interaction.

1. A system for non-verbal human communication comprising:
a sensing apparatus configured to detect a participant's mouth state as a binary biological signal representing open (O) and closed (C) conditions;
a signal processing module configured to convert the detected binary biological signal into time-stamped temporal sequences including state duration, transition patterns, and latency intervals;
an interpretation engine configured to translate the temporal sequences into symbolic and linguistic output using adaptive pattern recognition and user-specific behavioral modeling;
a latency modeling module configured to distinguish between intentional signal output and non-semantic biological delay, including classification of neutral latency conditions;
a persistent memory subsystem configured to store and update user-specific response patterns using a forgiveness-based memory architecture that tolerates variability, delay, and inconsistency;
a continuous validation engine configured to:
monitor input signals, temporal sequences, and interpretation outputs in real time,
verify signal integrity and temporal coherence,
evaluate contextual alignment with prior interactions, and
prevent propagation of erroneous, unsafe, or inconsistent interpretations;
an offline symbolic update interface configured to:
receive encoded visual or symbolic inputs representing system updates, configuration changes, or abstract instructions,
decode said inputs into machine-readable data,
perform local validation of such inputs prior to execution, and
apply validated updates without reliance on external network connectivity;
an output generation module configured to produce linguistic or symbolic representations of interpreted user intent;
wherein:
the system operates as a fully offline, self-contained architecture;
.interpretation of binary biological signals is adapted to individual user timing, variability, and context;
delayed or irregular signals are treated as non-semantic unless validated as intentional input; and
all system outputs are subject to continuous validation prior to delivery.

2. The system of claim 1, wherein the continuous validation engine further evaluates physiological and contextual signals to detect distress, fatigue, or abnormal behavior and modifies system interaction accordingly.

3. The system of claim 1, wherein the forgiveness-based memory architecture performs drift correction by reinforcing consistent patterns and reducing the influence of anomalous or noisy inputs.

4. The system of claim 1, wherein the interpretation engine progressively evolves from binary response interpretation to multi-choice and structured communication based on observed user interaction patterns.

5. The system of claim 1, further comprising an environmental awareness module configured to incorporate ambient audio, motion, and lighting data to contextualize interpretation of binary

6. The system of claim 1, wherein the sensing apparatus includes a self-centering camera and illumination subsystem configured to maintain continuous focus on the participant's mouth under variable environmental conditions.

7. The system of claim 1, wherein the persistent memory subsystem builds a personalized vocabulary and response model specific to the participant.

8. The system of claim 1, further comprising a session management module configured to track ongoing interactions, unresolved signals, and user state, and to preserve continuity across sessions.

9. The system of claim 1, wherein the latency modeling module dynamically adjusts timing windows based on user-specific behavior and physiological conditions.

10. The system of claim 1, wherein the continuous validation engine enforces an ethical interaction framework that prevents coercion, misinterpretation, and unsafe system behavior.

11. The system of claim 1, wherein the offline symbolic update interface utilizes encoded visual patterns or symbolic representations to deliver updates in an air-gapped environment.

12. The system of claim 1, wherein the offline symbolic update interface is configured to:
receive a machine-interpretable visual symbol via an optical sensor of the system, the visual symbol comprising a structured arrangement of graphical elements encoding configuration data or update instructions;
decode the visual symbol into machine-readable configuration data or executable instructions;
validate the decoded data using the locally executed continuous validation engine based on predefined integrity, authenticity, and compatibility criteria; and
apply the validated configuration data or instructions to the system without requiring network or cloud connectivity;
wherein distinct graphical elements or regions of the visual symbol encode different types of configuration data, instructions, or control parameters.

13. The system of claim 1, wherein the offline symbolic update interface performs integrity verification, compatibility validation, and replay protection prior to applying updates.

14. The system of claim 1, wherein the system maintains versioned internal state snapshots to support continuity of operation and autonomous recovery without external connectivity.

15. The system of claim 1, wherein the continuous validation engine performs multi-stage validation including signal-level, sequence-level, and context-level verification prior to output generation.

16. The system of claim 1, wherein the interpretation engine prioritizes user intent over strict temporal or structural consistency through adaptive convergence mechanisms.

17. The system of claim 1, wherein the offline symbolic update interface operates without any active network interface and restricts update ingestion to locally received optical, physical, or direct proximity-based inputs.
